(19) United States
(12) Patent Application Publication
(10) Pub. No.: US 2012/0176250 A1
(43) Pub. Date: Jul. 12, 2012

(54) SYSTEM AND METHOD FOR INTEGRATED DOWNHOLE SENSING AND OPTICAL FIBER MONITORING

(75) Inventors: Roger G. Duncan, Christiansburg, VA (US); Robert M. Harman, Troutville, VA (US); Alexander M. Barry, Roanoke, VA (US); Brooks A. Childers, Christiansburg, VA (US); Philip Robin Couch, Devon (GB)

(73) Assignee: BAKER HUGHES INCORPORATED, Houston, TX (US)

(21) Appl. No.: 12/985,845

(22) Filed: Jan. 6, 2011

(51) Int. Cl. G01V 3/00

(52) U.S. Cl. 340/853.2

(57) ABSTRACT

A system for measuring downhole parameters is disclosed. The system includes: a carrier configured to be disposed in a borehole in an earth formation; at least one optical fiber sensor in operable communication with the carrier; a measurement assembly including an electromagnetic signal source configured to transmit a first interrogation signal into the optical fiber sensor and a detector configured to receive a reflected signal indicative of a downhole parameter in response to the interrogation signal; and a processor configured to automatically receive scattered signals from the optical fiber sensor, generate distributed scattering data indicative of a condition of the optical fiber sensor and analyze changes in the distributed scattering data to identify changes in the condition of the optical fiber sensor.

### BACKGROUND

Fiber-optic sensors have been utilized in a number of applications, and have been shown to have particular utility in sensing parameters in harsh environments. Utilizing optical fibers downhole can present particular challenges when they are located in harsh environments. An optical fiber sensor can be damaged or otherwise compromised due to, for example, degradation, breakage and excessive deformation. When a fiber optic sensor's functionality is suspect, the cause can be difficult to diagnose remotely, which may require sending field service personnel to access wells in order to gather additional information.

### SUMMARY

A system for measuring downhole parameters includes: a carrier configured to be disposed in a borehole in an earth formation; at least one optical fiber sensor in operable communication with the carrier; a measurement assembly including an electromagnetic signal source configured to transmit a first interrogation signal into the optical fiber sensor and a detector configured to receive a reflected signal indicative of a downhole parameter in response to the interrogation signal; and a processor configured to automatically receive scattered signals from the optical fiber sensor, generate distributed scattering data indicative of a condition of the optical fiber sensor and analyze changes in the distributed scattering data to identify changes in the condition of the optical fiber sensor.

A method of measuring downhole parameters includes: disposing a carrier and at least one optical fiber sensor in a borehole in an earth formation; transmitting a first interrogation signal into the optical fiber sensor and receiving a reflected signal indicative of a downhole parameter in response to the interrogation signal; automatically receiving scattered signals from the optical fiber sensor; and generating, by a processor, distributed scattering data from the scattered signals indicative of a condition of the optical fiber sensor and analyzing changes in the distributed scattering data to identify changes in the condition of the optical fiber sensor.

### BRIEF DESCRIPTION OF THE DRAWINGS

Referring now to the drawings, wherein like elements are numbered alike in the several Figures:

FIG. 1 is a cross-sectional view of an embodiment of a downhole drilling, monitoring, evaluation, exploration and/or production system;

FIG. 2 is a cross-sectional view of an embodiment of an optical fiber sensor of the system of FIG. 1; and

FIG. 3 is a flow diagram illustrating a method of measuring downhole parameters and monitoring the condition of one or more optical fiber sensors.

### DETAILED DESCRIPTION OF EXEMPLARY EMBODIMENTS

There are provided systems and methods for monitoring the condition of optical fiber sensors to allow for detection of potential problems. A reflectometry system is integrated with a fiber optic sensing system configured for measurement of downhole parameters of a formation, a borehole and/or downhole components. The integrated reflectometry system is configured as a monitoring system and can periodically or on an as needed basis interrogate an optical fiber and/or collect distributed scattering data relative to the optical fiber. The distributed scattering data may be analyzed automatically or in response to a user command to estimate conditions of the optical fiber and identify potential faults by, for example, comparing the distributed scattering data to previously collected data. The reflectometry system may utilize an already existing measurement source and/or measurement unit, or may include an additional source and/or processing unit for fiber optic sensor monitoring. In one embodiment, the reflectometry system is configured as an Optical Time Domain Reflectometry (OTDR) and/or an Optical Frequency Domain Reflectometer (OFDR) system.

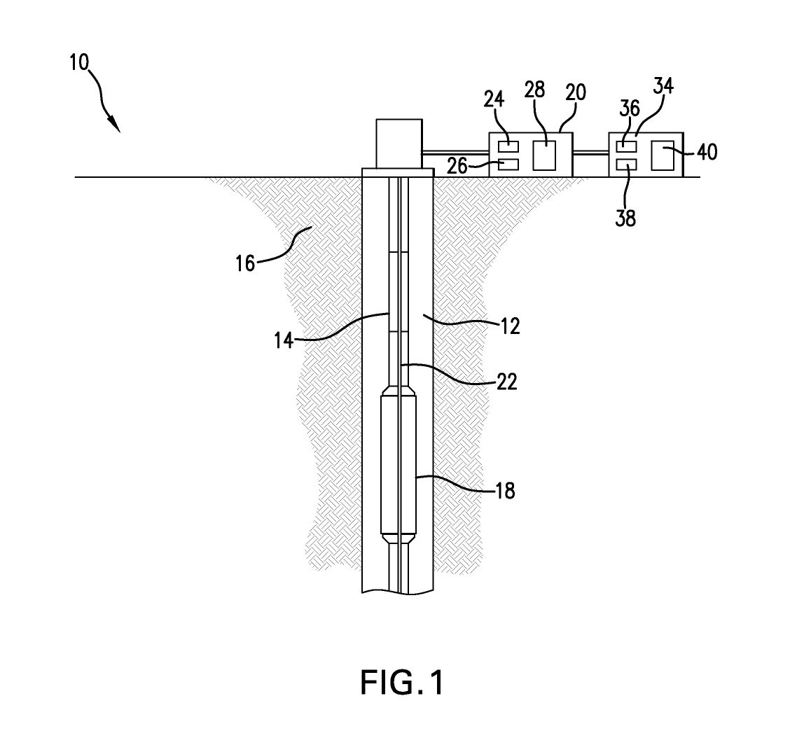

Referring to FIG. 1, an exemplary embodiment of a downhole drilling, monitoring, evaluation, exploration and/or production system 10 disposed in a wellbore 12 is shown. A borehole string 14 is disposed in the wellbore 12, which penetrates at least one earth formation 16 for performing functions such as extracting matter from the formation and/or making measurements of properties of the formation 16 and/or the wellbore 12 downhole. The borehole string 14 is made from, for example, a pipe, multiple pipe sections or flexible tubing. The borehole string 14 includes for example, a drilling system and/or a bottomhole assembly (BHA). The system 10 and/or the borehole string 14 include any number of downhole tools 18 for various processes including drilling, hydrocarbon production, and formation evaluation (FE) for measuring one or more physical quantities in or around a borehole. Various measurement tools 18 may be incorporated into the system 10 to affect measurement regimes such as wireline measurement applications or logging-while-drilling (LWD) applications.

In one embodiment, a downhole parameter measurement system is included as part of the system 10 and is configured to measure or estimate various downhole parameters of the formation 16, the borehole 14, the tool 18 and/or other downhole components. Examples of such parameters include temperature, pressure, vibration, strain and deformation of downhole components, chemical composition of downhole fluids or the formation, acoustic events, and others. The measurement system includes a measurement unit such as a surface measurement unit 20 connected in operable communication with at least one optical fiber sensor 22. The measurement unit 20 includes, for example, an electromagnetic signal source 24 such as a pulsed light source, tunable light source, a LED and/or a laser, and a signal detector 26. In one embodiment, a processor 28 is in operable communication with the signal source 24 and the detector 26 and is configured to control the source 24 and receive reflected signal data from the detector 26.

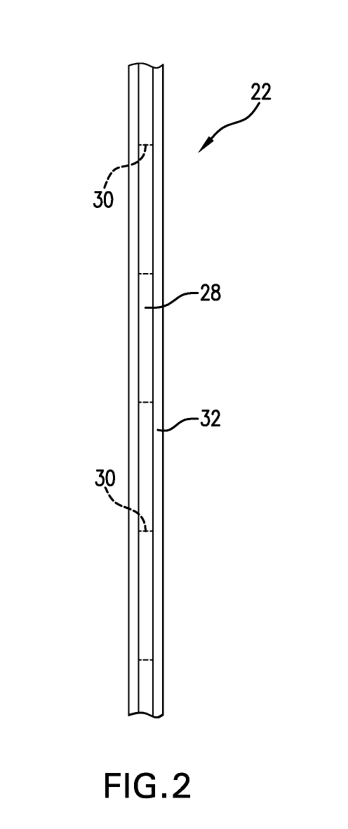

Referring to FIG. 2, the optical fiber sensor 22 includes at least one optical fiber 28 having one or more sensing locations 30 disposed along the length of the optical fiber sensor 22. The sensing locations 30 are configured to reflect interrogation signals transmitted by the measurement unit 20. Examples of sensing locations include fiber Bragg gratings (FBG), mirrors, Fabry-Perot cavities and locations of intrinsic scattering. Locations of intrinsic scattering include points in or lengths of the fiber that reflect interrogation signals, such as Rayleigh scattering, Brillouin scattering and Raman scattering locations. The optical fiber sensor 22 may also include a protective sleeve 32 or other outer layer, such as a metallic tube or a cable jacket configured to protect the optical fiber 28 from the downhole environment. In one embodiment, the fiber optic sensor 22 includes a plurality of optical fiber sensors and/or optical fibers 28 disposed in one or more cables or other conduits.

One example of the measurement system is a distributed fiber optic strain and/or deformation measurement system, which includes at least one fiber optic sensor 22 disposed at a fixed position relative to the tool 18, the borehole string 12 and/or other downhole components. In one embodiment, the fiber optic sensor 22 includes a plurality of sensing locations 30 such as FBGs formed along the length of at least one optical fiber 28. In this embodiment, the optical fiber sensor 22 is configured to deform due to displacements, deformations and strains in the borehole string 12, tool 18 and/or other components, and is configured to measure strain or deformation due to a corresponding deformation or bending (e.g., microbending) of the optical fiber sensor 22. The sensing locations reflect an interrogation signal transmitted from, for example, the measurement unit 20, and return the reflected signals to the measurement unit 20. Wavelength shifts in a return signal relative to the interrogation signal may indicate strain or deformation at or near a corresponding sensing location 30. Another example of a measurement system is a distributed temperature sensing (DTS and/or DDTS) system including at least one DTS/DDTS optical fiber sensor 22.

Referring again to FIG. 1, the system 10 also includes an optical fiber sensor monitoring system that is integrated with the measurement system. The monitoring system is configured to collect reflected signal data from the optical fiber sensor 22 to determine a change in the state or condition of the optical fiber sensor 22. Such a change in state may indicate whether or not an optical fiber has broken or otherwise been damaged, experiences an increase in loss or attenuation, has regions of high loss, or exhibits other problems. Determination of such changes in state can be used to identify problems with the optical fiber and enable rapid diagnosis of problems so that remedial actions can be taken.

The monitoring system, in one embodiment, includes a monitoring unit 34 that is configured to automatically collect distributed scattering data from the optical fiber sensor 22 and analyze changes in the distributed scattering data to identify changes in the condition of the optical fiber sensor 22. Distributed scattering data, as described herein, includes data from intrinsically scattered signals (e.g., Rayleigh scattering), reflected signals from other sensing locations 30 (e.g., FBGs), as well as reflected signals from fiber connections or cleaved fiber ends.

In one embodiment, the monitoring unit 34 is a distinct component separate from the measurement unit 20. For example, the monitoring unit 34 includes a signal source 36 configured to transmit an electromagnetic monitoring signal into the optical fiber sensor 22 and a signal detector 38. A processor 40 may be in operable communication with the signal source 36 and the detector 38 and may be configured to control the source 36 and receive reflected signal data from the detector 38.

In one embodiment, the monitoring system is incorporated into the measurement unit 20 and utilizes the processor 28, the signal source 24 and/or the detector 26 therein to collect the distributed scattering data. In this embodiment, the surface measurement unit 20 performs both the function of measuring downhole parameters and monitoring the condition of the optical fiber sensor 22. Accordingly, descriptions of the monitoring unit 34 may be understood to include a separate monitoring unit or may include the measurement unit 20.

The processor 28 and/or the processor 36, in one embodiment, is configured to automatically generate and/or collect distributed scattering data related to signals reflected from the optical fiber sensor 22 in response to the interrogation signals (e.g., DTS signals) generated as part of the measurement system functions. The processor 28, 36 may automatically generate and/or collect the data on a substantially continuous basis, periodically or on an as-needed basis in response to an instruction from a user or remote unit. The distributed scattering data may be generated and/or collected from reflected signals detected in response to interrogation signals from the measurement unit 20 and/or in response to separate monitoring signals transmitted from the monitoring unit 40 or the measurement unit 20 specifically for monitoring the condition of the optical fiber sensor 22.

In one embodiment, the monitoring system is configured as an optical time-domain reflectometry (OTDR) system. The OTDR monitoring system measures the fraction of light that is reflected back due to, for example, Rayleigh scattering and Fresnel reflection. By comparing the amount of light scattered back at different times, the monitoring system can determine conditions such as fiber and connection losses. The measurement unit 20 or the monitoring unit 34 transmits one or more optical pulses through the optical fiber sensor 22. If the interrogation signals used by the measurement unit 20 to measure downhole parameters are pulsed, these signals may be used to collect distributed scattering data, or separate signals may be generated by the measurement and/or monitoring unit. In one embodiment, if the measurement unit 20 utilizes a continuous tuned source 24 for measuring downhole parameters, the processor 40 (or 28) can be configured to control the tuned source 24 to sufficiently simulate a pulsed source for monitoring the optical fiber sensor 22.

For each pulse, the monitoring unit 34 measures the reflected signal returning over time and correlates each signal with a location based on the signal's arrival time. In one embodiment, the processor 40 processes the reflected signal as distributed scattering data in the form of, for example, an OTDR trace of the amount of backscattered light at any point in the optical fiber sensor 22.

The trace can be analyzed to estimate various conditions of the optical fiber sensor 22. For example, the distributed scattering data may be processed to correlate the location of each signal and the power (e.g., in dB) of each signal. Differences in the measured power over a selected distance provides loss measurements, and the optical fiber attenuation coefficient can be derived from the slope of the trace. Losses at specific locations may be indicative of mechanical connections or splices. These conditions may be compared to known values, or changes in these conditions relative to previously collected traces may be used to indicate a problem with the optical fiber sensor 22. Fiber attenuation can be measured, for example, by the two point method or the least squares method.

In one embodiment, the monitoring system is configured as an optical frequency-domain reflectometry (OFDR) system. In this embodiment, the source 36 and/or the source 24 includes a continuously tunable laser that is used to spectrally interrogate the optical fiber sensor 22. Scattered signals reflected from intrinsic scattering locations, sensing locations 30 and other reflecting surfaces in the optical fiber sensor 22 may be detected, demodulated, and analyzed. Each scattered signal can be correlated with a location by interferometrically analyzing the scattered signals in comparison with a selected common reflection location. Each scattered signal can be integrated to reconstruct the total shape of the cable.

In one embodiment, the measurement unit 20, the monitoring unit 34 and/or other components of the system 10 include devices as necessary to provide for storing and/or processing data collected from the optical fiber sensor 22 and other components of the system 10. Exemplary devices include, without limitation, at least one processor, storage, memory, input device, communications adapter, optical fiber coupler, splice box, output devices and the like.

The optical fiber measurement system and the monitoring system are not limited to the embodiments described herein, and may be disposed with any suitable carrier. The optical fiber sensor 22, the borehole string 14 and/or the tool 18 may be embodied with any suitable carrier. A “carrier” as described herein means any device, device component, combination of devices, media and/or member that may be used to convey, house, support or otherwise facilitate the use of another device, device component, combination of devices, media and/or member. Exemplary non-limiting carriers include drill strings of the coiled tube type, of the jointed pipe type and any combination or portion thereof. Other carrier examples include casing pipes, wirelines, wireline sondes, slickline sondes, drop shots, downhole subs, bottom-hole assemblies, and drill strings.

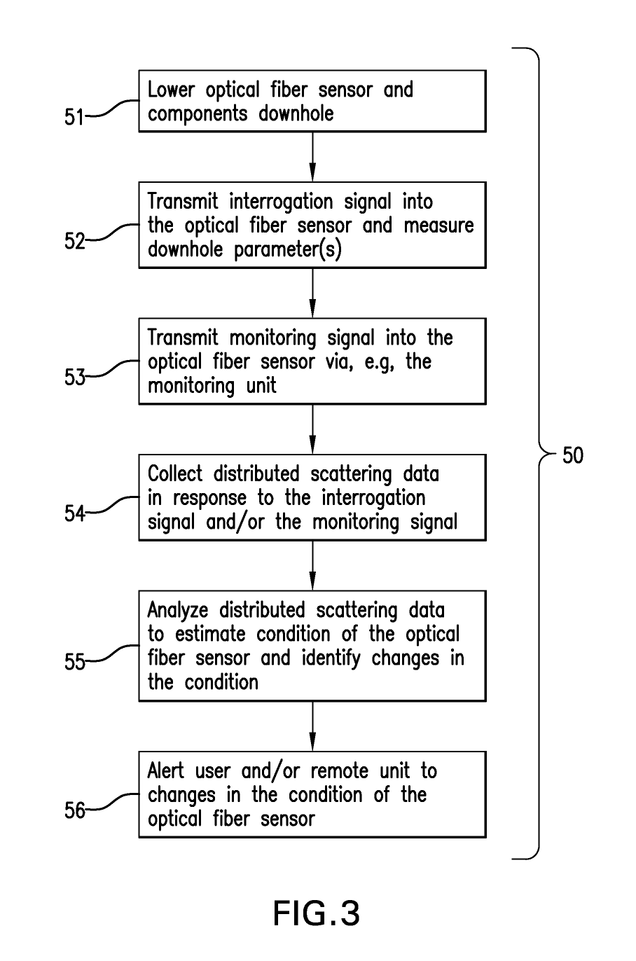

FIG. 3 illustrates a method 50 of measuring downhole parameters and monitoring the condition of one or more optical fiber sensors, such as the optical fiber sensor 22. The method 50 includes one or more stages 51-56. Although the method 50 is described in conjunction with the monitoring unit 34 described above, the method 50 is not limited to use with these embodiments, and may be performed by the measurement unit 20 or other processing and/or signal detection device. In one embodiment, the method 50 includes the execution of all of stages 51-56 in the order described. However, certain stages may be omitted, stages may be added, or the order of the stages changed.

In the first stage 51, the optical fiber sensor 22 along with the borehole string 12, tools 18 and/or other components are lowered downhole. The components may be lowered via, for example, a wireline or a drillstring.

In the second stage 52, various downhole parameters are estimated by the measurement system. An electromagnetic interrogation signal is transmitted to the optical fiber sensor 22 via, for example, the surface measurement unit 20. Return signals from FBGs or other sensing locations 30 are received and analyzed to generate measurements, such as a strain profile or a distributed temperature profile. Examples of the interrogation signal include pulsed signals and continuous wave signals.

In the third stage 53, in one embodiment, the monitoring unit 34 transmits a monitoring signal, i.e., an electromagnetic signal, and receives reflected signals from intrinsic scattering locations and sensing locations 30 in the optical fiber sensor 22. In one embodiment, the monitoring unit 34 transmits the monitoring signal as a pulsed signal via the electromagnetic source 36 as part of an OTDR technique. In one embodiment, the monitoring signal is a continuous OFDR signal. The monitoring signal may be automatically transmitted during, for example, a time period during which parameter measurements are performed. The monitoring signal may be transmitted continuously or periodically over a selected period of time.

In the fourth stage 54, the monitoring unit 34 collects intrinsic scattering data as well as data from other sensing units 30. In one embodiment, the monitoring unit 34 receives reflected signals in response to the measurement unit's interrogation signals and/or from any monitoring signals that are optionally generated as described in stage 53.

In the fifth stage 55, the monitoring unit 34 analyzes the distributed scattering data to estimate the condition of the optical fiber sensor 22 at various locations along the optical fiber sensor 22, and to identify changes in the condition of the sensor 22. In one embodiment, the monitoring unit 34 generates an OTDR or OFDR trace from the distributed scattering data, and estimates conditions such as fiber attenuation over selected lengths of the optical fiber sensor 22 and substantial losses corresponding to, for example, fiber connections or potential breaks in the optical fiber sensor 22. The monitoring unit 34 may compare the OTDR or OFDR trace to previously generated traces or other previously existing data related to the condition of the optical fiber sensor 22. Substantial changes in the condition of the optical fiber sensor 22, such as substantial changes in attenuation or other losses, may indicate damage to the optical fiber sensor 22, degradation or other changes to the optical fiber sensor 22 that may require remedial action.

In the sixth stage 56, the monitoring unit 34 alerts a user or another processing unit of the change in condition. For example, if a condition such as fiber attenuation or loss at a splice or other connection is identified as exceeding a selected threshold, or if a change in such condition relative to previously collected scattering data is above a certain threshold, the monitoring unit alerts the user by transmitting a message or displaying an alert to the user indicating a potential problem. In another example, the monitoring unit 34 may alert the user if a substantial loss is detected at a location that had not been detected previously, which may indicate a break or other damage to the optical fiber sensor 22 at that location.

The systems and methods described herein provide various advantages over prior art techniques. The systems and methods provide a mechanism for automatic monitoring and/collecting data related to the condition of optical fiber sensors, without the need for physical intervention. The systems and methods provide a way to remotely diagnose changes in such sensors without the need for sending field service personnel to access wells in order to gather additional information.

In support of the teachings herein, various analyses and/or analytical components may be used, including digital and/or analog systems. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for measuring downhole parameters, the system comprising:
a carrier configured to be disposed in a borehole in an earth formation;
at least one optical fiber sensor in operable communication with the carrier;
a measurement assembly including an electromagnetic signal source configured to transmit a first interrogation signal into the optical fiber sensor and a detector configured to receive a reflected signal indicative of a downhole parameter in response to the interrogation signal; and
a processor configured to automatically receive scattered signals from the optical fiber sensor, generate distributed scattering data indicative of a condition of the optical fiber sensor and analyze changes in the distributed scattering data to identify changes in the condition of the optical fiber sensor.

2. The system of claim 1, wherein the scattered signals include signals intrinsically scattered in response to the first interrogation signal.

3. The system of claim 1, wherein the scattered signals include signals intrinsically scattered in response to a second interrogation signal transmitted into the optical fiber sensor.

4. The system of claim 1, wherein the processor is configured to periodically collect the intrinsic scattering data.

5. The system of claim 1, wherein the processor is configured to compare the distributed scattering data to previously generated data to identify the change in condition.

6. The system of claim 1, wherein the change in condition is selected from a change in at least one of attenuation, received signal amplitude, received signal power and signal loss.

7. The system of claim 1, wherein the processor is configured to alert a user to the change in condition.

8. The system of claim 1, wherein the distributed scattering data is selected from at least one of optical time domain reflectometry (OTDR) and optical frequency domain reflectometry (OFDR) data.

9. The system of claim 1, wherein the distributed scattering data includes intrinsic scattering data collected based on intrinsically reflected signals received from intrinsic scattering locations disposed in a core of the optical fiber sensor.

10. The system of claim 9, wherein the intrinsically reflected signals are selected from at least one of Rayleigh scattering signals, Brillouin scattering signals and Raman scattering signals.

11. A method of measuring downhole parameters, the method comprising:
disposing a carrier and at least one optical fiber sensor in a borehole in an earth formation;
transmitting a first interrogation signal into the optical fiber sensor and receiving a reflected signal indicative of a downhole parameter in response to the interrogation signal;
automatically receiving scattered signals from the optical fiber sensor;
generating, by a processor, distributed scattering data from the scattered signals indicative of a condition of the optical fiber sensor and analyzing changes in the distributed scattering data to identify changes in the condition of the optical fiber sensor.

12. The method of claim 11, wherein the scattered signals include signals intrinsically scattered in response to the first interrogation signal.

13. The method of claim 11, wherein the scattered signals include signals intrinsically scattered in response to a second interrogation signal transmitted into the optical fiber sensor.

14. The method of claim 11, further comprising transmitting a second interrogation signal into the optical fiber sensor independently of the first interrogation signal.

15. The method of claim 14, wherein the second interrogation signal is selected from at least one of an optical time domain reflectometry (OTDR) signal and an optical frequency domain reflectometry (OFDR) signal.

16. The method of claim 11, further comprising comparing the distributed scattering data to previously generated data to identify the change in condition.

17. The method of claim 11, wherein the change in condition is selected from a change in at least one of attenuation, received signal amplitude, received signal power and signal loss.

18. The method of claim 11, further comprising alerting a user to the change in condition.

19. The method of claim 11, wherein the distributed scattering data includes intrinsic scattering data collected based on intrinsically reflected signals received from intrinsic scattering locations disposed in a core of the optical fiber sensor.

20. The method of claim 19, wherein the intrinsically reflected signals are selected from at least one of Rayleigh scattering signals, Brillouin scattering signals and Raman scattering signals.
